(19) United States
(12) Patent Application Publication
(10) Pub. No.: US 2023/0398508 A1
(43) Pub. Date: Dec. 14, 2023

(54) ANTI-SAGGING SPRAY CAN WITH STIRRING BEAD

(71) Applicant: KJ Applied Material Co., Ltd., Taichung City (TW)

(72) Inventors: CHIH-JUNG WU, Taichung City (TW); CHUAN-HSU TSAI, Taichung City (TW)

(21) Appl. No.: 17/835,856

(22) Filed: Jun. 8, 2022

(51) Int. Cl. B01F 33/25; B65D 83/14; B01F 33/501

(52) U.S. Cl. CPC B01F 33/251; B01F 2101/30; B01F 33/50111; B65D 83/752

(57) ABSTRACT

An anti-sagging spray can with stirring bead includes a can body, a stirring bead, a spray head, and a paint material. The can body has a top end and a containing space. The stirring bead is disposed in the containing space. The spray head is disposed on the top end. The spray head has an inner tube connected with the containing space. The paint material is contained in the containing space. The paint material includes a water-based polymer resin, a film-forming auxiliary, an auxiliary, a water-based color paste, and a deionized water. Thus, the present invention maintains an optimal spray effect of the sprayed paint material.

### BACKGROUND OF THE INVENTION

### 1. Field of the Invention

The present invention relates to fields of paint material spray can, and more particularly, to an anti-sagging spray can with stirring bead.

### 2. Description of the Related Art

A paint material spray can combines the functions of paint material storage and spraying. In addition to the usage of paint material storage, the spray can is used to spray the paint material to a designated position, thereby forming an even and beautiful paint material spray layer. The paint material spray can is structurally simple and easy to use, so as to be widely used in various fields such as wood spraying, wall spraying, plastic spraying, billboard spraying, and graffiti spraying.

However, regarding conventional paint material spray cans currently in use, several issues often occur, such as nozzle blockage, insufficient spray pressure, and reduced paint material viscosity during use. As a result, spraying efficiency is affected. Also, due to the uneven paint material flow, the coating often sags down on the painting layer around vertical planes, edges, and corners, resulting in a defective coating appearance, affecting the spraying effect.

### SUMMARY OF THE INVENTION

To improve the issues above, the present invention discloses an anti-sagging spray can with stirring bead capable of maintaining an optimal spraying effect of the sprayed paint material.

For achieving the aforementioned objectives, an anti-sagging spray can with stirring bead is provided, comprising a can body, a stirring bead, a spray head, and a paint material. The can body comprises a top end and a containing space. The stirring bead is disposed in the containing space. The spray head is disposed on the top end and comprises with an inner tube connected with the containing space. The paint material is contained in the containing space. The paint material comprises a water-based polymer resin, a film-forming auxiliary, an auxiliary, a water-based color paste, and a deionized water.

In an embodiment of the present invention, by weight of percentage, the paint material comprises 40% to 60% of water-based polymer resin, 10% to 20% of film-forming auxiliary, 1% to 2% of auxiliary, 5% to 16% of water-based color paste, and 20% to 40% of deionized water.

In an embodiment of the present invention, the viscosity of the paint material is 50 to 100 Pa·s.

In an embodiment of the present invention, the weight of the paint material is 100 to 200 grams.

In an embodiment of the present invention, the capacity of the containing space is 200 to 450 milliliters.

In an embodiment of the present invention, the containing space is filled with a compressed gas, which is selected from nitrogen, carbon dioxide, and hydrogen.

In an embodiment of the present invention, the pressure of the compressed gas is 5 to 20kg/cm².

In an embodiment of the present invention, the diameter of the stirring bead is 5 to 15 millimeters.

In an embodiment of the present invention, the spray head comprises a nozzle and a connection member. The connection member connects the nozzle and the can body, with one end of the inner tube passing through the connection member and combined with the nozzle, and the other end of the inner tube connected with the containing space.

In an embodiment of the present invention, the nozzle comprises a first channel, a second channel, and a spraying opening. The first channel is connected with the inner tube. The second channel is perpendicular to the first channel and disposed between the first channel and the spraying opening. The spraying opening is formed in a conical shape widening outward.

With such configuration, the anti-sagging spray can with stirring bead of the present invention effectively controls the viscosity of the paint material and the particles thereof. Thus, the coating formed of the sprayed paint material is prevented from having sagging issues. Also, the spraying process is less affected by wind blow, achieving an optimal spraying effect.

Also, with the stirring bead disposed in the containing space and the selection of filtered paint material, the paint material stored in the can body is prevented from sedimentation and condensation, avoiding blockage of the spray head.

### BRIEF DESCRIPTION OF THE DRAWINGS

FIG. 1 is a perspective view of the present invention.

FIG. 2 is a sectional view of the structure of the present invention.

FIG. 3 is a sectional view of the nozzle of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

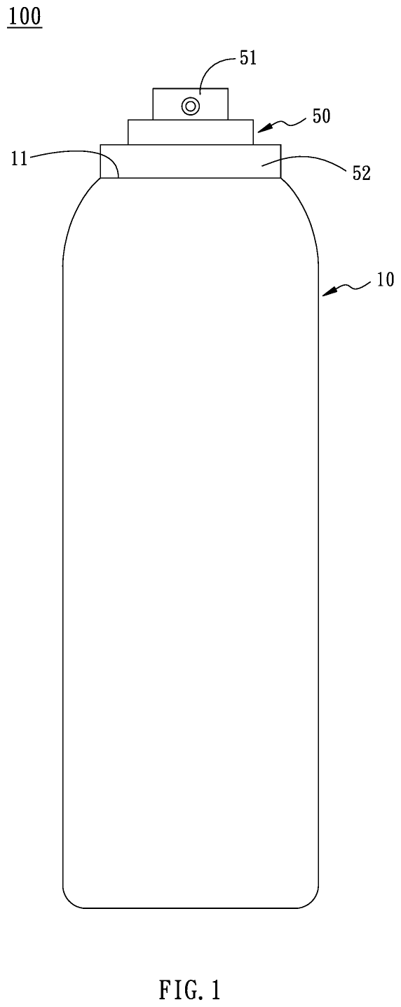

Referring to FIG. 1 to FIG. 3, the present invention provides an anti-sagging spray can with stirring bead 100, comprising a can body 10, a stirring bead 20, a paint material 30, a compressed gas 40, and a spray head 50. Therein, the stirring bead 20, the paint material 30, and the compressed gas 40 are disposed in the can body 10, and the spray head 50 is disposed on the can body 10.

The can body 10 comprises a top end 11 and a containing space 12. Therein, the capacity of the containing space 12 is 200 to 450 milliliters.

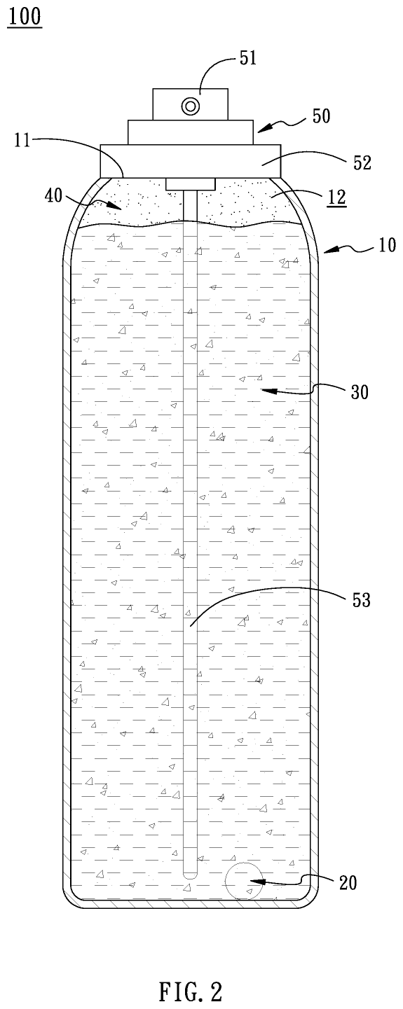

Referring to FIG. 2, the stirring bead 20 is disposed in the containing space 12. In the embodiment, the diameter of the stirring bead 20 is 5 to 15 millimeters; the stirring bead 20 is a glass ball.

The paint material 30 is contained in the containing space 12. The paint material 30 comprises a water-based polymer resin, a film-forming auxiliary, an auxiliary, a water-based color paste, and a deionized water. Therein, the paint material 30 is obtained through a 100 to 250-mesh filter screen. The viscosity of the paint material 30 is 50 to 100 Pa·s. Therein, the measurement standard of the viscosity of the paint material 30 is in accordance with spindle number 3 to 5. The weight of the paint material 30 is 100 to 200 grams.

In the embodiment, by weight of percentage, the paint material 30 comprises 40% to 60% of water-based polymer resin, 10% to 20% of film-forming auxiliary, 1% to 2% of auxiliary, 5% to 16% of water-based color paste, and 20% to 40% of deionized water.

Therein, the film-forming auxiliary is cetyl alcohol, dipropylene glycol methyl ether, dipropylene glycol butyl ether, or a combination thereof. The auxiliary is sheetlike silicate dispersion, bentonite, or a combination thereof. The water-based color paste is a white color, black color, red color, yellow color, blue color, and green color paste or a combination thereof.

The compressed gas 40 is filled in the containing space 12. The compressed gas 40 is selected from nitrogen, carbon dioxide, and hydrogen. In the embodiment, the pressure of the compressed gas 40 is 5 to 20kg/cm². Therefore, an appropriate compressed gas 40 is selected for completely spraying all the paint material 30. Therefore, the paint material 30 in storage is safely and completely sprayed from the containing space 12, thereby reducing the waste of paint material 30.

The spray head 50 is disposed on the top end 11. The spray head 50 comprises a nozzle 51, a connection member 52, and an inner tube 53. Therein, the connection member 52 is fixed to the can body 10, so as to connect the spray head 50 and the can body 10. One end of the inner tube 53 is connected with the nozzle 51, and the other end of the inner tube 53 is connected with the containing space 12.

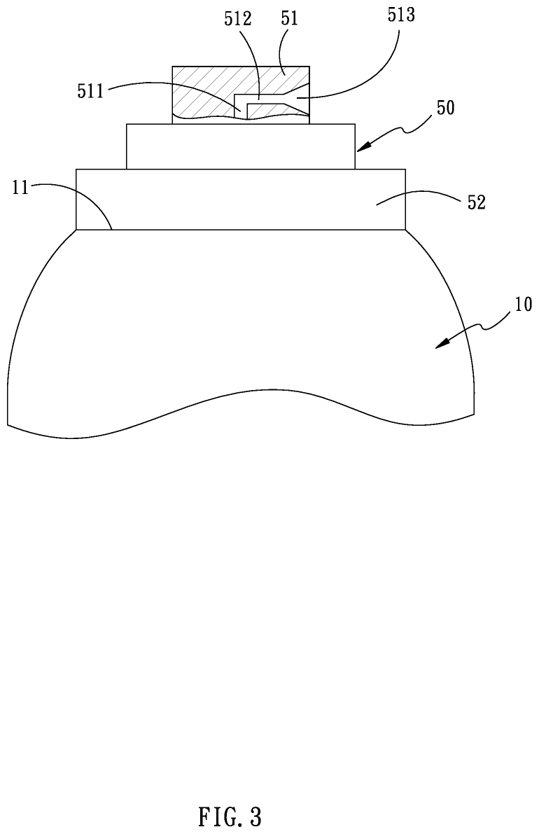

The spray head 51 comprises a first channel 511, a second channel 512, and a spraying opening 513. As shown by FIG. 3, the second channel 512 is perpendicular to the first channel 511 and disposed between the first channel 511 and the spraying opening 513 to connect the first channel 511 and the spraying opening 513. The spraying opening 513 is formed in an approximate conical shape widening outward.

One end of the inner tube 53 passes through the connection member 52 to be connected with the nozzle 51, so as to be sealed through a sealing member. The other end of the inner tube 53 is inserted into the containing space 12.

Therein, the first channel 511 is connected with the inner tube 53. When the user presses the nozzle 51, through the squeezing of the compressed gas 40 in the containing space 12, the paint material 30 in the containing space 12 passes the first channel 511 and the second channel 512 through the inner tube 53 to be sprayed from the spraying opening 513.

The operation method of the anti-sagging spray can with stirring bead 100 of the present invention is illustrated below. When not in use, the nozzle 51 is in a close status. The compressed gas 40 in the containing space 12 imposes a certain pressure upon the paint material 30. When the user needs to use the present invention, the user shakes the can body 10 before using the present invention to evenly mix the paint material 30 through the stirring bead 20, preventing the spraying opening 513 from being blocked by sedimentation and condensation. When using the present invention, the user opens the nozzle 51 for the paint material 30 to pass the inner tube 53 to be sprayed through the nozzle 51 onto the surface of the target by use of the pressure difference between the compressed gas 40 and the atmosphere.

The present invention will be described in detail below through the different embodiments. The protection scope of the present invention is not limited to the embodiments here. The embodiments and the features of the present invention are allowed to be combined with each other to obtain new embodiments without conflicts occurring therebetween.

### Embodiment 1

The capacity of the containing space 12 of the can body 10 is 250 milliliters.

The stirring bead 20 is a glass ball, whose diameter is 10 millimeters.

The viscosity of the paint material 30 is 98 Pa·s, wherein the measure standard of the viscosity of the paint material 30 is in accordance with spindle number 4.

The paint material 30 is obtained through a 200-mesh filter screen.

The weight of the paint material 30 is 150 grams.

The compressed gas 40 is nitrogen.

The pressure of the compressed gas 40 is 15 kg/cm².

### Embodiment 2

The capacity of the containing space 12 of the can body 10 is 230 milliliters.

The stirring bead 20 is a glass ball, whose diameter is 10 millimeters.

The viscosity of the paint material 30 is 88 Pa·s, wherein the measure standard of the viscosity of the paint material 30 is in accordance with spindle number 4.

The paint material 30 is obtained through a 150-mesh filter screen.

The weight of the paint material 30 is 160 grams.

The compressed gas 40 is nitrogen.

The pressure of the compressed gas 40 is 9.2 kg/cm².

### Embodiment 3

The capacity of the containing space 12 of the can body 10 is 270 milliliters.

The stirring bead 20 is a glass ball, whose diameter is 10 millimeters.

The viscosity of the paint material 30 is 84 Pa·s, wherein the measure standard of the viscosity of the paint material 30 is in accordance with spindle number 5.

The paint material 30 is obtained through a 180-mesh filter screen.

The weight of the paint material 30 is 160 grams.

The compressed gas 40 is carbon dioxide.

The pressure of the compressed gas 40 is 18 kg/cm².

### Embodiment 4

The capacity of the containing space 12 of the can body 10 is 220 milliliters.

The stirring bead 20 is a glass ball, whose diameter is 10 millimeters.

The viscosity of the paint material 30 is 65 Pa·s, wherein the measure standard of the viscosity of the paint material 30 is in accordance with spindle number 3.

The paint material 30 is obtained through a 220-mesh filter screen.

The weight of the paint material 30 is 130 grams.

The compressed gas 40 is carbon dioxide.

The pressure of the compressed gas 40 is 8 kg/cm².

With such configuration, the anti-sagging spray can with stirring bead 100 of the present invention effectively controls the viscosity of the paint material 30 and the particles thereof. Thus, the coating formed of the sprayed paint material is prevented from having sagging issues. Also, the paint material 30 of the spraying process is less affected by wind blow, achieving an optimal spraying effect of the paint material 30.

Also, with the stirring bead 20 disposed in the containing space 12 and the appropriately selected and filtered paint material 30, the present invention prevents the sedimentation and condensation of the paint material 30 in the can body 10, avoiding blockage of the spray head 50.

Further, the appropriately selected compressed gas 40 completely spray all the paint material 30. Therefore, the paint material 30 in storage is safely and completely sprayed from the containing space 12, thereby reducing the waste of paint material 30.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An anti-sagging spray can with stirring bead, comprising:
a can body comprising a top end and a containing space;
a stirring bead disposed in the containing space;
a spray head disposed on the top end, the spray head comprising an inner tube connected with the containing space; and
a paint material contained in the containing space, the paint material comprising a water-based polymer resin, a film-forming auxiliary, an auxiliary, a water-based color paste, and a deionized water.

2. The anti-sagging spray can with stirring bead of claim 1, wherein the water-based polymer resin accounts for 40% to 60% by weight percentage of the paint material, the film-forming auxiliary accounts for 10% to 20% by weight percentage of the paint material, the auxiliary accounts for 1% to 2% by weight percentage of the paint material, the water-based color paste accounts for 5% to 16% by weight percentage of the paint material, and the deionized water accounts for 20% to 40% by weight percentage of the paint material.

3. The anti-sagging spray can with stirring bead of claim 2, wherein a viscosity of the paint material is 50 to 100 Pa·s.

4. The anti-sagging spray can with stirring bead of claim 2, wherein a weight of the paint material is 100 to 200 grams.

5. The anti-sagging spray can with stirring bead of claim 1, wherein a capacity of the containing space is 200 to 450 milliliters.

6. The anti-sagging spray can with stirring bead of claim 1, wherein the containing space is filled with a compressed gas, which is selected from a group consisting of nitrogen, carbon dioxide, and hydrogen.

7. The anti-sagging spray can with stirring bead of claim 6, wherein a pressure of the compressed gas is 5 to 20 kg/cm².

8. The anti-sagging spray can with stirring bead of claim 1, wherein a diameter of the stirring bead is 5 to 15 millimeters.

9. The anti-sagging spray can with stirring bead of claim 1, wherein the spray head comprises a nozzle and a connection member; the connection member connects the spray head and the can body; one end of the inner tube passes through the connection member to be combined with the nozzle, and another end of the inner tube is connected with the containing space.

10. The anti-sagging spray can with stirring bead of claim 9, wherein the nozzle comprises a first channel, a second channel, and a spraying opening; the first channel is connected with the inner tube; the second channel is perpendicular to the first channel, and disposed between the first channel and the spraying opening; the spraying opening is formed in a conical shape widening outward.
